(19) United States
(12) Patent Application Publication
(10) Pub. No.: US 2016/0006325 A1
(43) Pub. Date: Jan. 7, 2016

(54) ELECTRIC MACHINE, IN PARTICULAR AN ENGINE

(71) Applicant: ATB SPIELBERG GMBH, Spielberg bei Knittelfeld (AT)

(72) Inventors: CHRISTIAN GRABNER, STEINHAUS AM SEMMERING (AT); SAMIR PEPELAR, HAAN (DE)

(21) Appl. No.: 14/769,542

(22) PCT Filed: Feb. 24, 2014
(86) PCT No.: PCT/AT2014/000038

§ 371 Date: Aug. 21, 2015

(30) Foreign Application Priority Data
Feb. 25, 2013 (AT) A 140/2013

(51) Int. Cl. H02K 11/00; H02K 9/06

(52) U.S. Cl. CPC H02K 11/0073; H02K 9/06

(57) ABSTRACT

An electric machine, in particular an engine, has a housing with a bearing shield, a drive shaft, a fan which is coupled to the drive shaft, and a converter. The converter is arranged between the fan and the bearing shield.

The invention relates to an electric machine, in particular a motor, which has a housing with an end plate, a drive shaft, a fan, which is coupled to the drive shaft, and a converter.

Electric motors have already been used for a long time for a variety of purposes. However, in order to be able to use the large bandwidth of possible uses of electric motors, a converter is necessary in many cases, which enables a continuous rotational-speed adjustment or a reversal in the direction of rotation, for example. In addition to the classic application in a control cabinet, said converter is generally accommodated on the outside of the motor or on a casing around the motor. In this case, it is disadvantageous that a converter housing accommodated on the outside of the motor increases the requirement on space of the motor.

The problem addressed by the invention is therefore to provide an electric machine with a converter, which reduces the above-mentioned disadvantages.

Said problem is solved by means of an electric machine of the type mentioned at the outset having the characterizing features of claim 1.

The electric machine may be constructed as known from the prior art. All types of electric motors which are operated in connection with converters, for example asynchronous, reluctance and/or permanent-magnet synchronous motors, are suitable. In principle, an arrangement according to the invention can also be used, however, if the electric machine is operated as a generator. The converter may contain a wide variety of electrical devices. In addition to circuits for controlling the motor rotational speed or direction of rotation, these may also comprise, for example, electrical suppressing devices or any other circuit usual in the operation of electric machines.

Fans coupled to the drive shaft of the motor are known in the prior art and usually cool the motor since the latter loses efficiency in the case of increasing temperature. If the converter is positioned between the motor and fan, a flow of air flowing from the fan to the motor likewise flows around the converter and hence cools it.

Furthermore, the motor gains a compact exterior in this way and is therefore particularly space-saving.

According to a preferred embodiment of the invention, the converter has a cutout through which the drive shaft runs. Thus, the converter can use the available space in a particularly efficient manner.

It is particularly preferred for the converter to be spaced apart from the end plate by a gap. Said gap reduces the thermal conduction between the converter and the electric machine. Moreover, the gap can be ventilated, which further improves the cooling.

In order to form the gap, a housing of the converter preferably has feet which are supported against the end plate and space apart the converter from the end plate.

According to a further development of the invention, the converter and the housing are thermally decoupled from one another. For this purpose, for example, the feet may be made from a material which is a particularly good thermal insulator.

According to another preferred embodiment of the invention, the fan has a fan housing which at least circumferentially surrounds the fan and the converter. Thus, air can be conducted past the converter to the motor. In a further development of the invention, the fan housing may have at least one guide device on its inner side which generates and/or amplifies air turbulence in the gap. Thus, the cooling of the motor and converter can be improved even further.

Preferred and advantageous embodiments of the invention are the subject matter of the dependent claims.

Further features and advantages of the invention emerge from the following description of a preferred exemplary embodiment of the invention with reference to the appended drawings, in which:

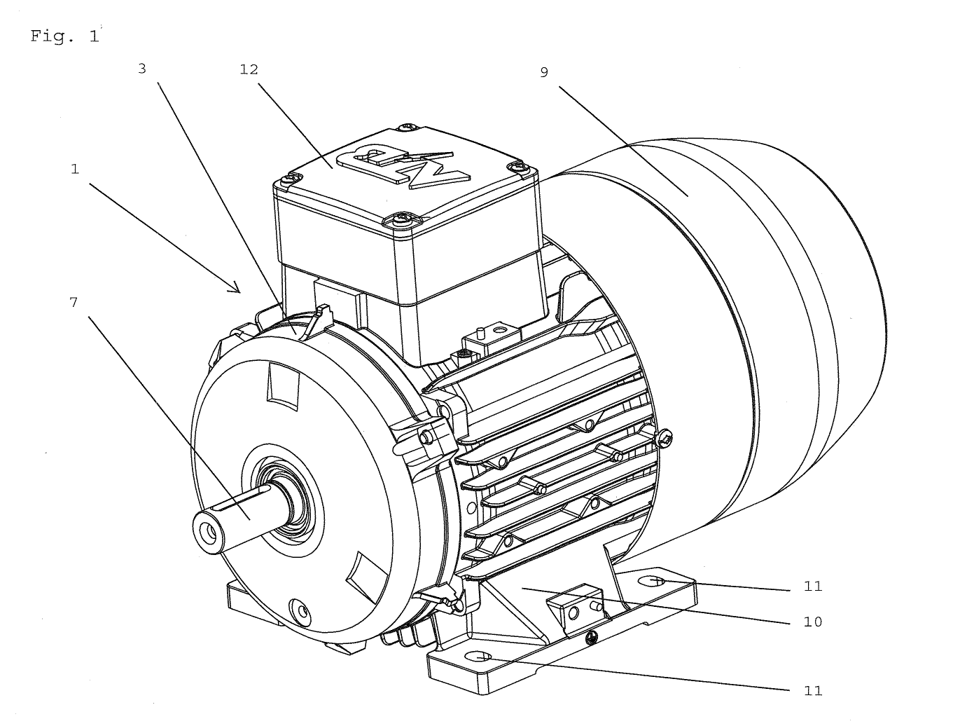

FIG. 1 shows an isometric view of a motor with converter according to the invention,

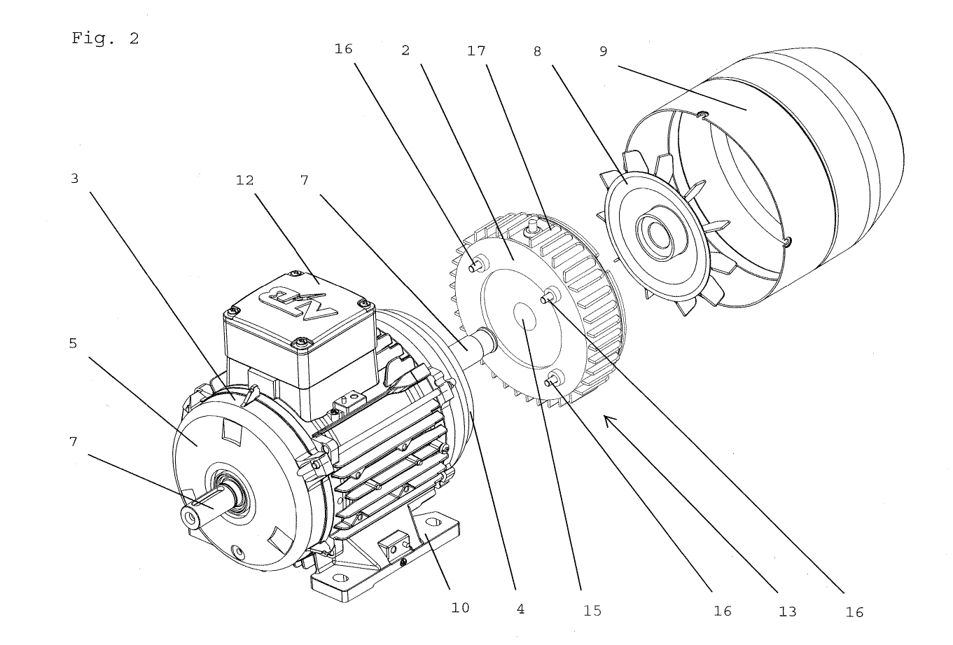

FIG. 2 shows an exploded drawing of the motor from FIG. 1, and

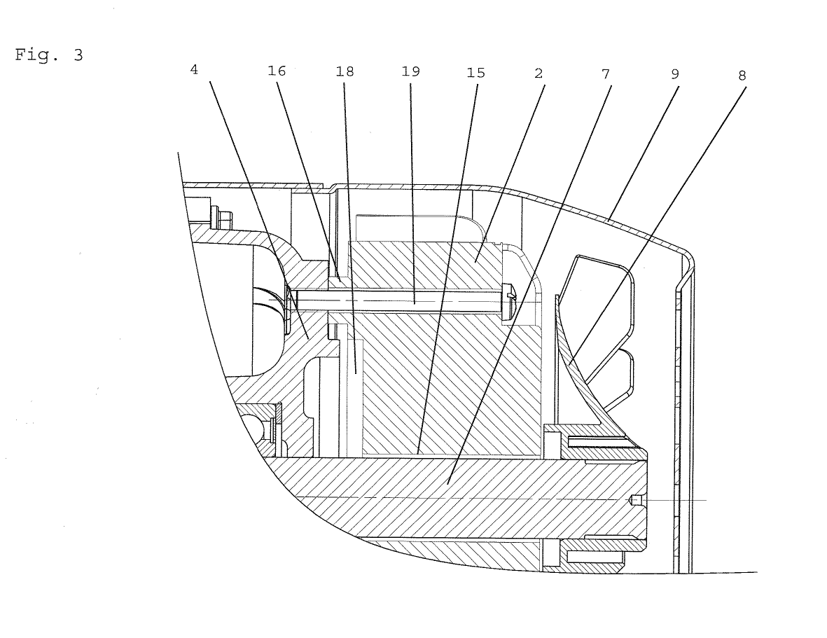

FIG. 3 shows an axial section through the fan-side end of the motor from FIG. 1.

The figures show a motor 1 according to the invention with a converter housing 13. Apart from the changes according to the invention, all of the components of the motor 1 may be embodied in a manner known from the prior art. Therefore, it is mentioned only in a very general way that an electric machine is arranged in a housing 3. The housing 3 has end plates 4, 5 and is substantially cylindrical in shape. A drive shaft 7 projects through the end plates 4, 5, in which it is mounted. The converter housing 13 and a fan 8 are completely covered in FIG. 1 by a fan housing 9. The end plate 4 is located on the fan-side end here. A fastening element 10, with which the motor 1 can be securely fastened in its location of use via holes 11, is located on the underside of the housing 3. A box 12 is located on the top of the housing 3. Said box offers space for connections and for electrical and/or electronic components, which are present in addition to the components housed in the converter housing 13. However, in a development of the invention, the box 12 may also be embodied substantially smaller or omitted completely. In this case, all of the electrics or electronics required for the operation of the motor are then housed in the converter housing 13 of the converter 2. In this case, the connections may be placed, for example, in a cutout of the fan housing. As a result of this, the motor can be configured to be even more compact.

A cutout 15 in the converter housing 13 can be seen in FIG. 2. In the assembled state, the drive shaft 7, which is coupled or connected to the fan 8, runs through said cutout 15.

The converter housing 13 is closed in the illustrated exemplary embodiment and spaced somewhat apart from the drive shaft 7 in order not to hinder the rotation of the drive shaft 7. Sensors which acquire, for example, the rotational speed or possible vibrations of the drive shaft 7 may also be arranged in the converter housing 13.

Feet 16 are arranged on the converter housing 13. Said feet are supported, in the assembled state, against the end plate 4 and thus define a gap 18 by which the converter 2 is spaced apart from the end plate 4. Preferably, the feet 16 are composed of a thermally insulating material and thus support thermal decoupling of the converter 2 from the electric machine.

In addition to the feet 16, the converter housing 13 has cooling ribs 17. In the illustrated exemplary embodiment, said cooling ribs are embodied as cooling ribs on motor housings usually are. Alternatively, however, the cooling ribs 17 may also be arranged obliquely or offset with respect to one another, for example, in order thus to conduct the flow of air generated by the fan 8 in another way or, for example, to cause turbulence, and to better surround the converter 2 and the housing 3 with air. Similarly, the fan housing 9 may also have ribs and/or guide plates on its inner side in order to deflect the flow of air or to cause turbulence or to conduct it into the gap 18 (FIG. 3) between the converter housing 13 and end plate 4.

FIG. 3 shows an axial section through the fan-side end of the motor 1. The gap 18 between the end plate 4 and the converter housing 13 can clearly be seen. The converter housing 13 is fastened to the housing 3 of the motor 1 by means of screws 19 which run through the feet 16. The drive shaft 7 runs substantially coaxially through the cutout 15 in the converter housing 13. Embodiments in which the converter is only partially covered by a converter housing 13, for example for better ventilation of the electronic components of the converter, or in which the converter 2 or the converter housing 13 is arranged eccentrically between fan 8 and end plate 4 are also conceivable.

1-9. (canceled)

10. An electric machine, comprising:
a housing having an end plate;
a drive shaft;
a fan coupled to said drive shaft; and
a converter disposed between said fan and said end plate of said housing.

11. The electric machine according to claim 10, wherein said converter has a converter housing.

12. The electric machine according to claim 11, wherein said converter housing is a substantially disk-shaped housing.

13. The electric machine according to claim 11, wherein said converter housing is spaced apart from said end plate with a gap formed therebetween.

14. The electric machine according to claim 11, wherein said converter housing is formed with a cutout and said drive shaft protrudes through said cutout.

15. The electric machine according to claim 11, wherein said converter housing has feet which are supported against the end plate and which space apart said converter housing from said end plate.

16. The electric machine according to claim 10, wherein said converter and said housing are thermally decoupled from one another.

17. The electric machine according to claim 11, which comprises a fan housing at least circumferentially surrounding said fan and said converter housing.

18. The electric machine according to claim 17, wherein said fan housing has guide devices on an inner side thereof.

19. The electric machine according to claim 10, configured as an electric motor.
